(19) United States
(12) Patent Application Publication
(10) Pub. No.: US 2003/0101276 A1
(43) Pub. Date: May 29, 2003

(54) Parallel lookup engine and method for fast packet forwarding in network router

(76) Inventors: Jaehyung Park, Daejeon (KR); Byung-Chun Jeon, Daejeon (KR); Yoo-Kyoung Lee, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/044,593

(22) Filed: Jan. 11, 2002

(30) Foreign Application Priority Data
Nov. 24, 2001 (KR) 01-73584

(51) Int. Cl. G06F 15/173; G06F 15/16

(52) U.S. Cl. 709/238; 709/203

(57) ABSTRACT

A parallel lookup engine and a method for a high-speed packet forwarding in a network router is provided. The parallel lookup engine includes: multiple lookup engines for performing packet forwarding lookup in parallel in the network router; and a selector for selecting and outputting the longest one of the lookup results performed by the multiple lookup engines. The parallel lookup method includes: (a) step of providing information about a desired key to multiple lookup engines; (b) step of identifying whether the provided key exists in each lookup engine; (c) step of retrieving a prefix tree and returning the information about the desired key in case the desired key exists in each lookup engine based on the result of step (b); and (d) step of selecting and outputting the longest value of the multiple data returned in step (c).

### BACKGROUND OF THE INVENTION

1. Field of the Invention

The present invention relates to a packet switching, and more particularly, to a parallel lookup engine in a network router and a method for performing a forwarding table lookup in parallel in order to search an appropriate output interface fast.

2. Description of the Related Art

In a packet-switched network, a router is a device which receives packets on one or more input interfaces and which outputs those packets on a plurality of output interfaces. Each packet includes header information which indicates the destination device, and the router includes routing information which associates an output interface with information about the destination device, so as to forward those packets within the network from a source device to a destination device. The router can also perform other operations on packets, such as rewriting the packets according to their routing protocol or re-encapsulating the packets from a first routing protocol to a second routing protocol. To that end, the router includes a forwarding engine dedicated to packet forwarding. The forwarding engine performs the operations according to the flow shown in FIG. 1 in order to forward packets.

FIG. 1 is a flow diagram showing how a forwarding engine in a network router forwards a packet. In FIG. 1, the forwarding engine extracts header information from the inputted packet in step 11, and verifies the accuracy of the header in step 12. In step 13, the forwarding engine extracts information about a destination and in step 14, performs a lookup intended to extract forwarding information associated with the destination information. Then, the forwarding engine extracts output interface information necessary for forwarding to the destination in step 15. In step 16, the forwarding engine changes the header of the packet and forwards the packet to the exterior in step 17.

With regard to retrieval of the destination information and others stored in the packet header, the forwarding table lookup (Refer to step 14.) is complex and requires too much time, since the lookup performance is dependent on access to the memory which contains a forwarding table including a specific destination information.

### SUMMARY OF THE INVENTION

To solve the above problem, it is the objective of the present invention to provide a parallel lookup engine in a network router and a method for forwarding packets in parallel and reducing the lookup time drastically.

### BRIEF DESCRIPTION OF THE DRAWINGS

The above object and advantages of the present invention will become more apparent by describing in detail preferred embodiments thereof with reference to the attached drawings in which:

FIG.1 is a flow diagram showing how a forwarding engine in a network router forwards a packet;

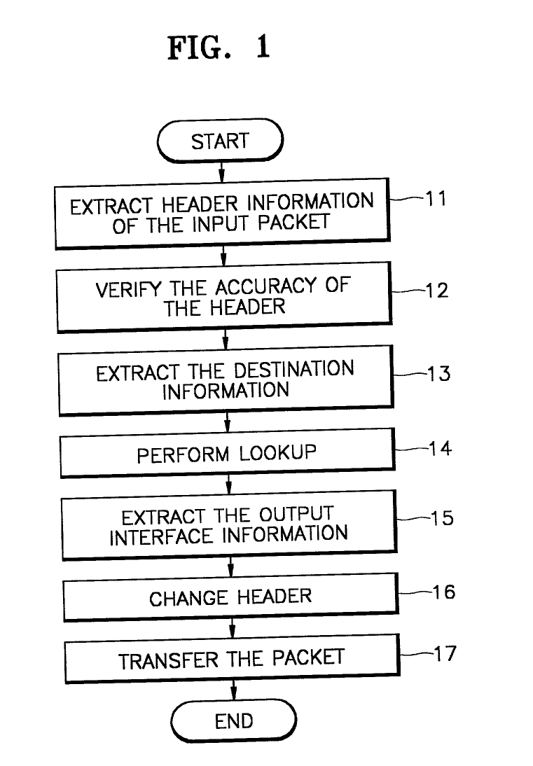

FIG. 2 is a block diagram showing a parallel lookup engine in a network router according to a preferred embodiment of the present invention;

FIG. 3 shows operations performed by an inspection device shown in FIG. 2;

FIG. 4 is a flow diagram of a method for a fast packet forwarding in a network router according to a preferred embodiment of the present invention; and

FIG. 5 is a flow diagram showing a parallel forwarding lookup according to a preferred embodiment of the present invention.

<Description of Numbers Assigned to Major Parts in FIGURES.>

| | |
|---|---|
| 100: parallel lookup engine | 110a-110z: lookup engine |
| 120a-120z: controller | 130a-130z: memory |
| 140a-140z: inspection device | 180: selector |

### DETAILED DESCRIPTION OF THE INVENTION

To achieve the above objective, a parallel lookup engine for a fast packet forwarding in a network router according to the present invention includes:

multiple lookup engines for performing packet forwarding lookup in parallel in the network router; and

a selector for selecting and outputting the longest one of the lookup results performed by the multiple lookup engines.

To achieve the above objective, a high-speed packet forwarding method in the network router according to the present invention includes:

(a) step of extracting header information from an inputted packet;

(b) step of verifying the accuracy of the header;

(c) step of extracting the destination information from the header;

(d) step of performing lookup in parallel intended to extract forwarding information associated with the destination information, using a prefix tree;

(e) step of extracting output interface information in response to the lookup result; and

(f) step of changing the packet header in response to the output interface information and forwarding the packet to the exterior.

To achieve the above objective, a parallel lookup method for a fast packet forwarding in the network router according to the present invention includes:

(a) step of providing information about a desired key to multiple lookup engines;

(b) step of identifying whether the provided key exists in each lookup engine;

(c) step of retrieving a prefix tree and returning the information about the desired key in case the desired key exists in each lookup engine based on the result of step (b); and

(d) step of selecting and outputting the longest value of the multiple data returned in step (c).

Preferred embodiments will be described in detail with reference to accompanying drawings below.

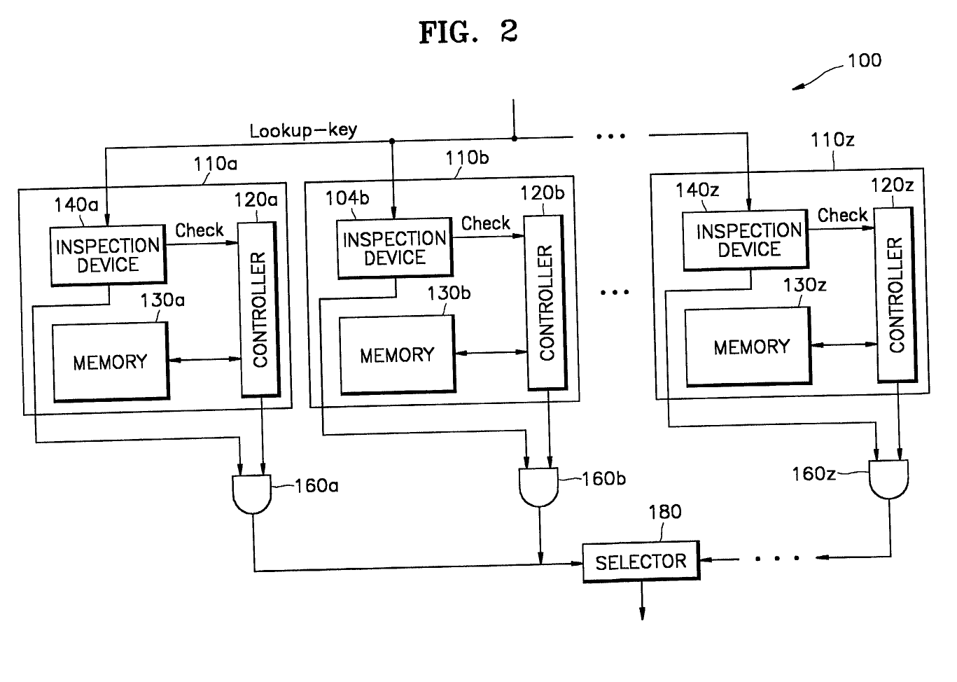

FIG. 2 is a block diagram showing a parallel lookup engine 100 in a network router according to a preferred embodiment of the present invention, which is designed to perform the forwarding table lookup faster. Referring to FIG. 2, the parallel lookup engine 100 according to the present invention includes multiple lookup engines 110a-110z and a selector 180 for selecting the longest value out of the lookup results performed by the lookup engines 110a-110z.

The lookup engines 110a-110z include controllers 120a-120z, memories 130a-130z and inspection devices 140a-140z. Outputs of the controllers 120a-120z and the inspection devices 140a-140z included in lookup engines 110a-110z are logic-multiplied 160a-160z and the results are transmitted to the selector 180. Detailed configuration and operation of the lookup engines 110a-110z for performing the forwarding lookup in parallel are described below.

The memories 130a-130z included in lookup engines 110a-110z store the forwarding information appropriately distributed to each lookup engine so that entries stored in the forwarding table may not be redundant. The forwarding information stored in the memories 130a-130z has a prefix tree data structure. The inspection devices 140a-140z receive the input data Lookup-Key extracted from the packet header, and identify if the forwarding information associated with the input data Lookup-Key is stored in the memories 130a-130z included in the lookup engines 110a-110z. Then, the inspection devices transmit the result to the controllers 120a-120z and the multipliers 160a-160z. In case it is identified that the forwarding information associated with the input data Lookup-Key is stored in the memories 130a-130z included in the lookup engines 110a-110z, the controllers 120a-120z retrieve the forwarding information in order to find out the output interface of the packet.

The input data Lookup-Key extracted from the packet header includes the destination address and other information (for example, source address). The lookup engines 110a-110z are notified of the information about the desired key by the input data Lookup-Key.

If the inspection devices 140a-140z receive the input data Lookup-Key, they identify if the input data Lookup-Key exists in their own lookup engines. If the key is stored in their own lookup engines, the inspection devices start to retrieve the data. In that case, if the key does not exist in their own lookup engines or they fail to retrieve the data, the inspection devices return the output value indicating ‘none’ to the controllers 120a-120z and the multipliers 160a-160z. The inspection devices 140a-140z identify whether the desired key Lookup-Key exists in their own lookup engines in the following way.

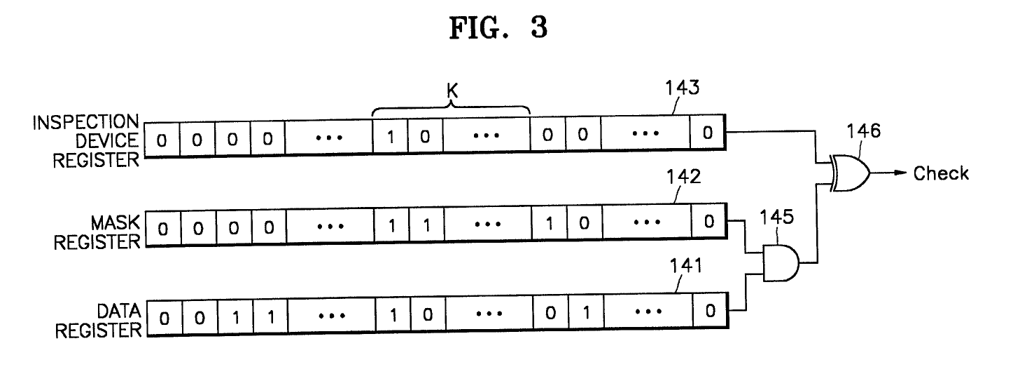

FIG. 3 shows operations performed by inspection devices 140a-140z shown in FIG. 2.

Referring to FIG. 3, each of the inspection devices 140a-140z includes a data register 141, a mask register 142 and an inspection device register 143. The inspection devices 140a-140z perform AND-operation 145 on the data stored in the data register 141 and the mask register 142 in order to identify if the inputted key value Lookup-Key exists in their own lookup engines. In the AND-operation, the inspection devices mask k (2^{k}=N) continuous bits (having a pre-defined length) out of the inputted key values Lookup-Key, and identify if the key Lookup-Key is the data stored in their own lookup engines based on the masking result. That is, the inspection devices 140a-140z compare the inputted key value Lookup-Key with the bit type of the inspection devices by performing the XOR-operation 146 on the data stored in the inspection device register 143 and the masking result. If the result of the XOR-operation 146 is 0 (that is, the bit type is the same), each inspection device judges that the data on the desired key value exists in its own lookup engine. If the result of the XOR-operation 146 is 1 (that is, the bit type is not the same), the inspection device judges that the data on the desired key value does not exist in its own lookup engine. Data stored in the inspection device register 143 varies depending on the lookup engines 110a-110z. The masking performed by the inspection devices 140a-140z can also apply to the data made up of k bits that are not continuous.

Referring to FIG. 2 again, if the inspection devices 140a-140z identify that the input key Lookup-Key is the data stored in their own look engines, the controllers 120a-120z retrieve the prefix trees stored in the memories 130a-130z and return the information about the desired key to the selector 180. The selector 180 selects the longest prefix of the values returned by the lookup engines 110a-110z and outputs the longest one as the lookup result of the forwarding engine.

If the lookup engines 110a-110z do not have the inspection devices 140a-140z, the lookup engines 110a-110z retrieve their own table memories 130a-130z and notify if the input key value Lookup-Key exists in their own lookup engines. In addition, since the lookup engines 110a-110z can have differently structured prefix trees, they can have high-performing prefix trees suitable for their own prefix data.

As described above, in the parallel lookup engine 100 according to the present invention, multiple lookup engines can perform the forwarding table lookup in parallel, using the prefix trees, and obtain the output interface information for forwarding to the destination fast.

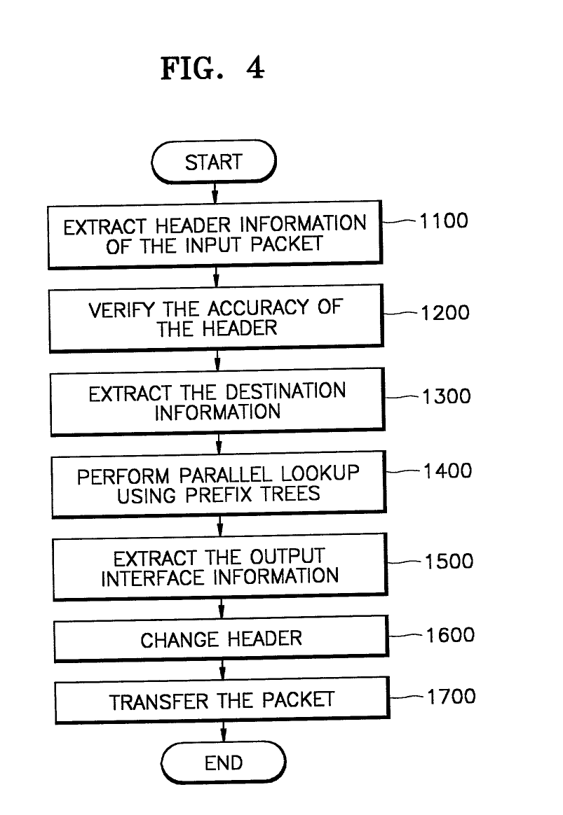

FIG. 4 is a flow diagram of a method for a fast packet forwarding in a network router according to a preferred embodiment of the present invention. As shown in FIG. 4, the lookup engines extract header information from the inputted packet in order to forward the packet in step 1100, and verify the accuracy of the header in step 1200. Then, the lookup engines extract the information about the destination in step 1300, and perform the lookup in parallel intended to extract the forwarding information associated with the destination information, using the prefix trees in step 1400. In step 1500, the lookup engines extract the output interface information for forwarding to the destination and in step 1600, change the packet header and in step 1700, forward the packet to the exterior. In the above procedure, the lookup engines can reduce the time required for the complex forwarding lookup in step 1400 drastically and forward the packets at a high speed.

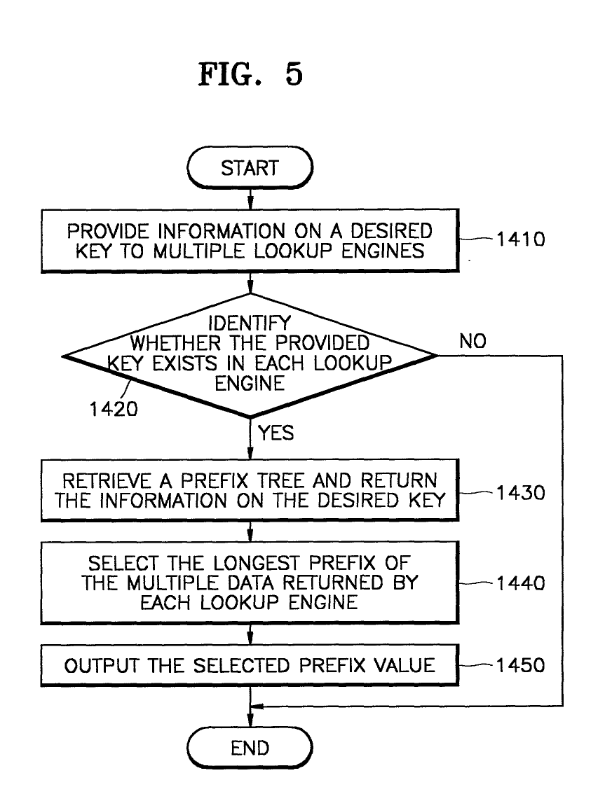

FIG. 5 is a flow diagram showing a parallel forwarding lookup according to a preferred embodiment of the present invention.

With reference to FIG. 5, the step 1400 of the parallel forwarding lookup shown in FIG. 4 is described below.

The lookup engines 110a-110z receive the information on the desired key Lookup-Key in step 1410. The inspection devices 140a-140z identify if the desired key Lookup-Key exists in their own lookup engines in step 1420. If the identification result proves the desired key Lookup-Key exists in their own lookup engines (that is, the memories 130a-130z), the controllers 120a-120z return the information on the desired key to the selector 180 by retrieving the prefix trees in step 1430. The selector 180 selects the longest prefix out of the values returned by the lookup engines 110a-110z in step 1440, and outputs the selected prefix value as the lookup result of the forwarding engine in step 1450.

To be more specific about the step 1420, the lookup engines identify if the masked bit is the same as the bit type stored in the inspection devices 140a-140z after masking k continuous bits on the provided key Lookup-Key. For example, if the masked bit is the same as the bit type stored in the inspection devices 140a-140z, it is deemed that the provided key Lookup-Key exists in their own lookup engines (that is, memories 130a-130z).

As described above, according to the parallel lookup method of the present invention using the prefix tree, since the forwarding lookup is performed in parallel, the forwarding engine dedicated to the packet forwarding in the packet switching router can perform the lookup fast.

The embodiments of the present invention present multiple parallel lookup engines implemented separately from the packet forwarding engine. However, the present invention can also be applied to the forwarding table lookup in the packet forwarding engine.

In addition, the present invention can be implemented as a computer-readable code in the computer-readable recording media. The computer-readable recording media include all types of recording devices where data that can be read by the computer system is stored. The computer-readable recording media include ROM, RAM, CD-ROM, a magnetic tape, a floppy disc and an optical data storage device. In addition, the present invention can be implemented in the form of a carrier wave (for example, transmission over the Internet). The computer-readable recording media can be distributed to the computer systems in a network and stored and executed as computer-readable codes in a distributed way.

What is claimed is:

1. A parallel lookup engine for fast packet forwarding in a network router comprising:
multiple lookup engines for performing packet forwarding lookup in parallel in the network router; and
a selector for selecting and outputting the longest one of the lookup results performed by the multiple lookup engines,
wherein each lookup engine comprising:
a memory for saving forwarding information appropriately distributed to each lookup engine so that entries stored in the forwarding table may not be redundant;
an inspection device for receiving input data extracted from the packet header and identifying if the forwarding information associated with the input data is stored in the memory; and
a controller for retrieving the forwarding information necessary to find out the output interface of the packet in case the forwarding information associated with the input data proves to be stored as a result of the identification of the inspection device.

2. The parallel lookup engine of claim 1, wherein the memory stores the forwarding information in a prefix tree data structure.

3. The parallel lookup engine of claim 2, wherein the memory has a prefix tree structure that is different from that of the memory included in other lookup engine.

4. The parallel lookup engine of claim 1, wherein the inspection device masks k continuous bits out of the inputted data and identifies if the masked data is the same as the bit type stored in the inspection device, and if the identification result is yes, judges that the forwarding information associated with the input data is stored in the memory.

5. The parallel lookup engine of claim 4, wherein the bit stored in the inspection device varies depending on the forwarding information stored in the memory.

6. The parallel lookup engine of claim 1 or 2, wherein the controller selects and outputs the longest value out of multiple values the same as the prefix having a specific length and the input data in retrieving the forwarding information.

7. The parallel lookup engine of claim 1, wherein the input data includes at least one of the destination information and the source information extracted from the packet header.

8. A high-speed packet forwarding method in a network router includes;
(a) step of extracting header information from an inputted packet;
(b) step of verifying the accuracy of the header;
(c) step of extracting the destination information from the header;
(d) step of performing lookup in parallel intended to extract forwarding information associated with the destination information, using a prefix tree;
(e) step of extracting output interface information in response to the lookup result; and
(f) step of changing the packet header in response to the output interface and forwarding the packet to the exterior.

9. The method of claim 8, wherein step (d) comprises:
(d-1) step of providing information about a desired key to multiple lookup engines;
(d-2) step of identifying whether the provided key exists in each lookup engine;
(d-3) step of retrieving a prefix tree and returning the information about the desired key in case the desired key exists in each lookup engine after the result of step (d-2); and
(d-4) step of selecting and outputting the longest value of the multiple data returned in step (d-3).

10. A parallel lookup method for a fast packet forwarding in a network router comprising:
(a) step of providing information about a desired key to multiple lookup engines;
(b) step of identifying whether the provided key exists in each lookup engine;
(c) step of retrieving a prefix tree and returning the information about the desired key in case the desired key exists in each lookup engine after the result of step (b); and
(d) step of selecting and outputting the longest value of the multiple data returned in step (c).

11. The method of claim 10, wherein step (b) comprises:
(b-1) step of masking k continuous bits out of the provided key;
(b-2) step of identifying if the masked bit in step (b-1) is the same as the bit type stored in the lookup engine; and
(b-3) step of judging that the provided key exists in the lookup engine in case the masked bit is the same as the bit type in step (b-2).

12. The method of claim 11, wherein the bit compared with the masked bit in step (b-2) varies depending on the forwarding information stored in the lookup engine.

13. A computer-readable recording medium for recording a program intended to execute one method of claims 10 through 13 in a computer.
